(19) United States
(12) Patent Application Publication
(10) Pub. No.: US 2006/0282265 A1
(43) Pub. Date: Dec. 14, 2006

(54) Methods and apparatus to perform enhanced speech to text processing

(76) Inventors: Steve Grobman, El Dorado Hills, CA (US); Joe Gruber, West Chester, OH (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/150,007

(22) Filed: Jun. 10, 2005

(51) Int. Cl. G10L 17/00

(52) U.S. Cl. 704/246

(57) ABSTRACT

A method, apparatus, and articles of manufacture to perform speech to text conversion are disclosed. One example method of performing speech to text conversion at a first location includes determining an identity of a speaker, accessing a directory to determine a location at which speaker dependent training data associated with the speaker is stored, loading speaker dependent training data associated with the speaker, and performing speech to text conversion using the speaker dependent training data associated with the speaker.

### TECHNICAL FIELD

The present disclosure pertains to speech processing and, more particularly, to methods and apparatus to perform enhanced speech to text processing.

### BACKGROUND

The desire to convert speech to text has long existed. The first speech to text (STT) or voice recognition (VR) systems were manual systems in which while one person spoke, a second person keyed the spoken words into a typewriter in real time. The advent of magnetic storage media for voice recording enabled the first person to dictate words onto a media, such as a tape, that could be replayed at a later and more convenient time for the second person who performed the transcription.

The widespread use of the personal computer gave rise to renewed interest in STT systems. Using known STT systems, such as, for example, Dragon NaturallySpeaking and the like, a computer user could speak into a microphone and have his/her voice converted into words that appeared on a display screen.

STT systems may be generally classified as speaker independent or speaker dependent. Speaker independent systems are not conditioned to a particular speaker's voice and, thus, are geared to recognize words spoken by a number of different speakers. Speaker dependent voice recognition systems are user-specific systems that must be “trained” by a speaker reading proscribed words into the systems to enable the system to recognize the manner in which such words sound when uttered by the speaker. In general, speaker dependent systems have high recognition accuracy and better performance in noisy environments than their speaker independent counterparts. Additionally, speaker dependent systems generally operate using less processing memory and can perform STT conversion at a higher rate that speaker independent systems. However, as noted above, speaker dependent systems must be voice trained by each speaker to be recognized.

Currently, STT systems focus on converting speech to text for users that are executing computing applications on a particular computing system. That is, modern STT systems are trained by a particular speaker whose speech will be converted to text and that speaker dependent training data (SDTD) remains on that trained system. Current STT systems do not support mechanisms for applications to access SDTD for other users who have not trained a particular platform. For example, if speaker A trains platform A and speaker B trains platform B, there is no mechanism for platform A to use speaker B's STDT because that data resides on platform B. In such a situation, platform A would be forced to convert speaker B's speech to text using speaker independent techniques, which are less efficient and less effective.

### BRIEF DESCRIPTION OF THE DRAWINGS

FIG. 1 is a system diagram including various STT systems and components.

FIG. 2 is a functional block diagram of a STT converter that may be implemented on a processor of FIG. 1.

FIG. 3 is a flow diagram of a peer exchange process that may be carried out in the system of FIG. 1.

FIG. 4 is a flow diagram of a multiparty call center process that may be carried out by the system of FIG. 1.

FIG. 5 is a flow diagram of a STT enhancement process that may be carried out by the system of FIG. 1.

FIG. 6 is a flow diagram of a STT multiplex process that may be carried out by the system of FIG. 1.

FIG. 7 is a block diagram of an example processor system on which certain aspects of STT processing may be carried out.

FIG. 8 is a block diagram showing additional detail of one example driver level configuration that may be implemented on the processor system of FIG. 7.

FIG. 9 is a block diagram showing additional detail of a second example driver level configuration that may be implemented on the processor system of FIG. 7.

### DETAILED DESCRIPTION

Disclosed herein are numerous speech to text enhancements, each of which utilizes speaker dependent training data. The techniques disclosed herein include peer-to-peer exchange of SDTD, event-based transcription using SDTD, the use of SDTD in response to speaker recognition, and the multiplexing of speech and transcription information using SDTD.

As will be readily appreciated by those having ordinary skill in the art, SDTD data can be packaged such that it is transportable between platforms. This is the case for proprietary implementations of SDTD data in which the portability will be limited to the systems based on the proprietary format. However as the benefits of exchanging SDTD are realized, it is likely that standard binary formats will emerge that will allow divergent systems based on different platforms to exchange and use common SDTD based on industry standards.

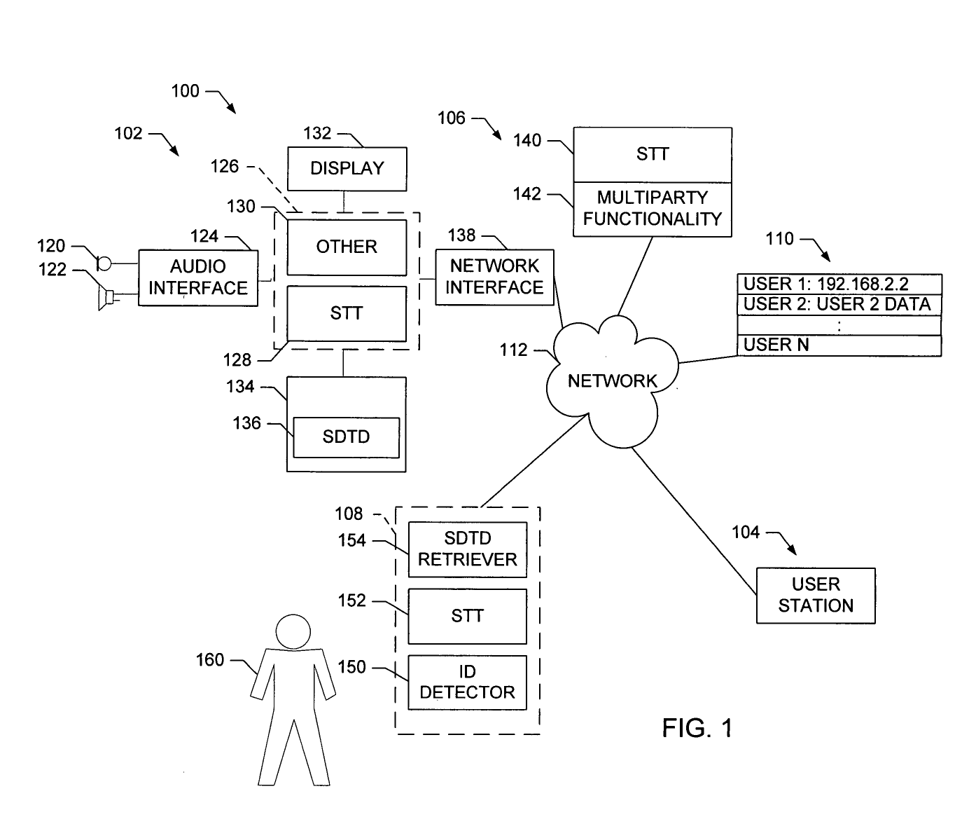

FIG. 1 shows an example STT system 100 including a first and second user stations 102, 104, a multiparty station 106, a kiosk station 108 including STT functionality, and an SDTD directory/repository 110. Some or all of the stations 102, 104, 106, 108 and the SDTD repository 110 may be interconnected through a network 112. The detail of each of the foregoing components is provided below in conjunction with descriptions of how the components interact to provide STT functionality. In general, the STT system 100 illustrates a number of components that may be used in different combinations to convert speech to text using SDTD when such data is available.

The first and second user stations 102, 104 include similar components and/or subsystems to provide STT functionality using SDTD. Accordingly, only the detail of the first user station 102 is shown in FIG. 1 and following description is provided in conjunction the first user station 102. Of course, as will be readily appreciated by those having ordinary skill in the art, the first and second user stations 102, 104 may include components that differ from one another.

The first user station 102 includes audio input/output devices, such as a microphone 120 and a speaker 122. The microphone 120 and the speaker 122 may be integrated together into a headset arrangement or may be separate components that are not physically connected. Alternatively, the microphone 120 and the speaker 122 may form a portion of a telephone, such as a telephone handset. As described below, during operation a user speaks into the microphone 120 and hears audio from the speaker 122. One example of such a system is one in which a uses the microphone 120 and the speaker 122 are used together as a telephone handset. As described in further detail below, other components in the STT system 100 may receive audio and convert it to text so that the text may be read or otherwise processed.

Regardless of their configuration, the microphone 120 and the speaker 122 are coupled to an audio interface 124, which may be implemented using a computer audio card including a connection to receive audio from the microphone 120 and a connection to provide an audio output signal to the speaker 122. In the alternative, the audio interface 124 may be implemented using integrated audio capabilities, such as may be found in chipsets or other audio hardware. Additionally, the audio interface 124 may be implemented using an audio system that is external to a computer, such as a universal serial bus (USB) audio system. The audio interface 124 converts information between analog audio signals and digital data. For example, the audio interface 124 receives an analog audio signal from the microphone via an electrical connection and converts such a signal to packets of digital data that may be processed by computational resources. Additionally, digital data, in the form of packets or otherwise, may be received at the audio interface 124 from computational resources. The audio interface 124 converts such digital data into analog audio that is manifest by the speaker 122.

The first user station 102 also includes a processing portion 126 including STT functionality 128, as well as other functionality 130. A display device 132 is coupled to the processing portion 126 to provide visual feedback regarding the processing performed by the processing portion 126. A data store 136, which stores SDTD 136, is also coupled to the processing portion 126. The first user station 102 also includes a network interface 138 to couple the processing portion 126 to the network 112.

The processing portion 126 may be implemented by a computing system, such as a processor system similar or identical to the system of FIG. 7. Accordingly, the STT functionality 128 and the other functionality 130 may be implemented using hardware, firmware, or software executed by a processor system. These methods include, but are not limited to, statistical models based on acoustic, “word and unit,” and language. Products implementing these capabilities include core OS libraries in OSX and Windows, as well as dedicated speech recognition engines such as those included in Dragon Speak and IBM's speech to text products. However, it should be noted that the most pronounced use of this capabilities will be in new products that currently do not use STT, such as VOIP. The other functionality 130 may be conventional processing such as may be carried out by computing system, which may include word processing, Internet browsing, or other functionality.

The multiparty station 106 of the example of FIG. 1 includes a STT module 140, as well as multiparty functionality 142. The multiparty station 106 may also include a SDTD database (not shown). The multiparty station 106 may be implemented using a processing system executing firmware or software to facilitate STT and multiparty functionality. As described below in detail, the multiparty station 106 may be a call center into which a number of parties call to participate in a conference call event, via the network 112. In such an arrangement, the multiparty station 106 receives voice information from a number of callers and accesses SDTD associated with those callers to facilitate the conversion of the speakers' voices to text. After the voices are converted to text, the text may be e-mailed, printed, posted to an Internet website, or manipulated in any other way that text would normally be handled in a computing system.

The kiosk station 108 may be used in a number of different situations including, for example, drive through windows, etc. The kiosk station 108 includes an identification detector (ID detector) 150, STT functionality 152, and an SDTD retriever 154. A user 160 who, in prior situations would place orders or provide other communication via voice, is detected by the ID detector 150. For example, the ID detector 150 may sense an attribute of the user 160 such as fingerprints, or other biometric information. Alternatively, the ID detector 150 may prompt a user to input his or her identity via a keyboard or other input device. As further alternative, the ID detector 150 may be capable of reading a device, such as, for example, a radio frequency identification (RFID) device associated with the user 160.

After the identity of the user 160 is determined, the SDTD retriever 154 locates SDTD associated with the user 160. The SDTD may be stored locally within the kiosk station 108 or the SDTD retriever 154 may access the SDTD directory/repository 110 (described below) to obtain the SDTD information or an address at which the SDTD may be found. Subsequently, the STT functionality 152 uses the SDTD to convert the speech of the user 160 into text that may be used to augment the understanding the spoken word of the user 160. For example, in a drive through window example, order fidelity may be enhanced because the person staffing the drive through window would be able to see as well as hear the words spoken by the user 160. The speech recognition may be enhanced through the use of the SDTD that was previously not available in such circumstances.

The SDTD directory/repository 110 provides SDTD services to other entities in the system 100. For example, if an entity is in need of SDTD for a particular user, that entity may access the SDTD directory/repository 110 and either obtain the user data directly or obtain a pointer to a location at which the subject SDTD is stored. The SDTD directory/repository 110 may be implemented using a processing system such as a server, a personal computer, or the like. The SDTD directory/repository 110 may include pointers to or SDTD for a number of users. For example, as shown in FIG. 1, the SDTD directory/repository 110 includes an entry for User 1 and identifies that the SDTD for User 1 may be found at the IP address 192.168.2.2. Of course, those having ordinary skill in the art will readily recognize that the SDTD directory/repository 110 need not specify the location of SDTD using IP addresses and that locations may be specified by uniform resource locators (URLs) or in any other suitable manner that may be used to identify a file location either on a local system (e.g., in SDTD directory/repository 110 itself) or on a system connected to the SDTD directory/repository 110 via the network 112. Additionally or alternatively, the SDTD directory/repository 110 may include the STDT directly. For example, as shown in FIG. 1, the SDTD for User 2 may be stored locally.

The network 112 may be any network. For example, the network 112 may be a wide area network (WAN) such as the Internet, a telephone network, a wireless network, or any other network covering a broad geographical area. Alternatively, the network 112 may be a local area network (LAN) that covers a relatively small geographical area relative to a WAN. Of course, the network 112 may be constructed of a number of different types of networks (e.g., LANs, WANs, etc.). Additionally, the network may include a number of different media, such as wireless, wired, optical, and other suitable interconnections.

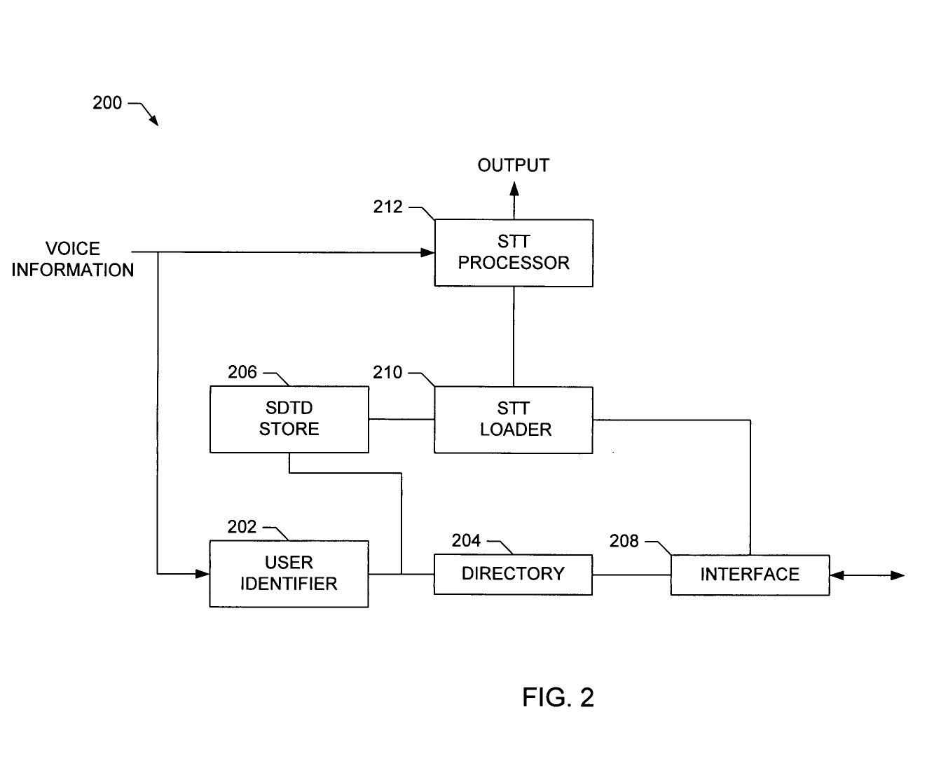

FIG. 2 is a block diagram of one example implementation of a STT converter 200 that may be used to implement the functionality referred to in FIG. 1. The STT converter 200 includes a user identifier 202 that identifies the speaker associated with the voice information that is being converted to text. As will be readily appreciated, the speaker may be local to the STT converter 200 or may be located remotely and connected via a network connection. A directory 204 receives the identity of the speaker from the user identifier 202 and attempts to locate SDTD for the speaker. It should be noted that the directory 204 could be located remotely from the STT converter 200. The directory 204 may obtain the SDTD for the speaker from a local SDTD store 206 or from another location that is available via the interface 208 that is connected to a network (e.g., the network 112).

The SDTD for the speaker is coupled to the SDTD loader 210, which passes the SDTD to a STT processor 212. The STT processor 212 receives the SDTD along with the voice information and converts the voice information to text and outputs the same. The output may be provided to a display screen or to any suitable storage media.

The following includes a description of a number of processes. These processes may be implemented using one or more software programs or sets of instructions or codes that are stored in one or more memories (e.g., the memories 706, 708, and/or 710 of FIG. 7) and executed by one or more processors (e.g., the processor 702). However, some of the blocks of these processes may be performed manually and/or by some other device. Additionally, although the processes are described with reference to flowcharts, persons of ordinary skill in the art will readily appreciate that many other methods of performing these processes may be used. For example, the order of many of the blocks may be altered, the operation of one or more blocks may be changed, blocks may be combined, and/or blocks may be eliminated.

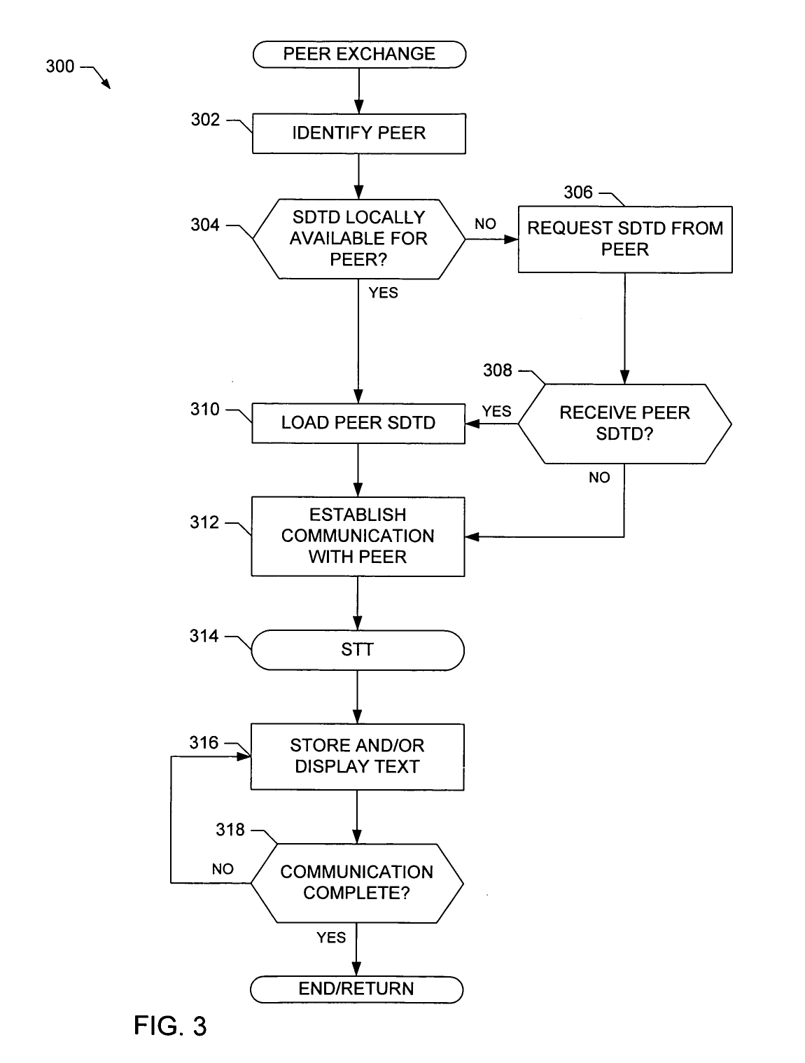

FIG. 3 is a flow diagram of an example peer exchange 300 process that may be carried out between user stations, such as the user stations 102, 104 of FIG. 1, to exchange respective SDTD. For example, the example peer exchange process 300 would be carried out when a first user at the user station 102 is setting up a call over the network 112 with a second user at the user station 104. As described in detail below, each user station 102, 104 is aware of the SDTD for its respective user. To perform STT processing using SDTD, the user stations 102, 104 exchange SDTD.

As the process 300 begins, a peer with which the voice conversation is to take place is identified 302. This may be carried out during peer exchange of SDTD during which the connection between the peers is already established and a simple network negotiation may be used to determine if the peer has the SDTD cached (optional). If the peer does not have the SDTD cached, the SDTD will be transferred and associated with the connection and, therefore, the peer.

After the identity of the peer is determined (block 302), the process 300 determines if the SDTD is locally available for the peer (block 304). This may be carried out by accessing a directory listing locally stored SDTD. If the SDTD is not locally available (block 304), the SDTD is requested from the peer (block 306). For example, the user station 102 requests the SDTD from the user station 104.

If the SDTD is received (block 308), the peer SDTD is loaded (block 310) so that it may be used by STT functionality to enhance the accuracy and speed of the STT conversion. Alternatively, if the peer SDTD is not received (block 308) or after the peer SDTD is loaded (block 310), communication is established with the peer (block 312) and STT conversion is commenced (block 314), either with the benefit of SDTD (if such data is available) or without the benefit of SDTD (if such data is not available).

As the STT process is carried out (block 314), the process 300 stores and/or displays the text resulting from the voice being converted into text (block 316). This conversion of voice or speech to text (block 316) will continue until the communication is complete (block 318).

The foregoing addressed a situation in which SDTD is provided by one peer to another peer. However, as an alternative, a directory/repository (e.g., the SDTD directory/repository 110 of FIG. 1) may be accessed to determine if SDTD for the peer is available. The accessing of a directory/repository may be carried out rather than, or in combination with, requesting SDTD from the peer.

As a further alternative, rather than exchanging SDTD, one of the peers (e.g., one of the user stations 102, 104) may be designate to act as the STT converter for the conversation. In such an arrangement, the SDTD of one of the peers needs only to be ported to the other peer so that STT may be carried out using the SDTD of each peer.

Additionally or alternatively, it is possible that SDTD may be used to identify a speaker, rather than convert a speaker's voice to text. In such arrangements, the exchange of SDTD profiles is useful for not only STT functions, but also to aid in identifying who is currently speaking during a group conference call. This functionality is useful for scenarios in which the participants of the call may not be familiar with the voices of the participants.

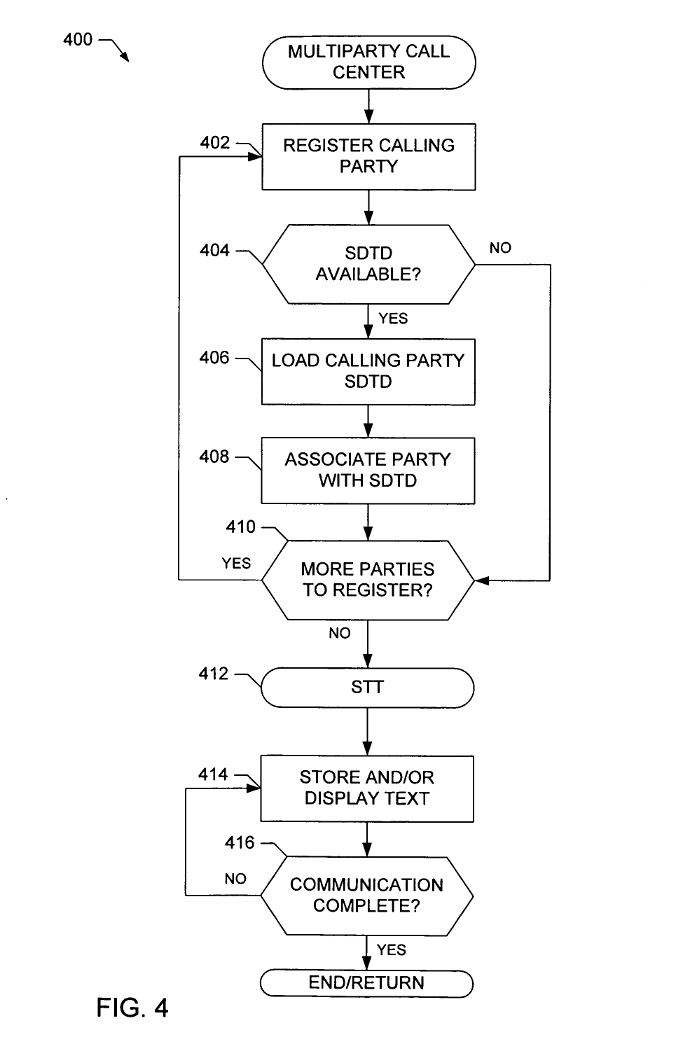

Referring to FIG. 4, a multiparty call center process 400 is disclosed. The process 400 may be carried out by, for example, multiparty station, such as the multiparty station 106 of FIG. 1. In general, the multiparty call functionality is used to facilitate communication commonly referred to as a conference call. The process 400 begins by registering a calling party (block 402), during which the identity of the calling party is provided or determined. The identity may be determined by requesting the caller to key in identification, by monitoring caller identification information, etc.

If no SDTD is available for the calling party (block 404), it is determined if there are more parties to register (block 406). The availability of SDTD may be determined by requesting SDTD from the caller's system or by accessing a local or remote directory/repository. If there are more parties to register (block 406), the process returns to block 402, at which point the calling parties are registered.

Alternatively, if it is determined that SDTD is available for the calling party (block 404), the calling party SDTD is loaded (block 408), and the loaded SDTD is associated with the calling party (block 410) so that the SDTD of the calling party can be used to convert the caller's voice to text in a speaker dependent manner.

When there are no more parties to register (block 406), STT processing may be started (block 412) and storage or display of the text may be carried out (block 414). Alternatively, the STT processing may be started before all parties are registered, thereby enabling an ongoing conversation to be transcribed into text before all parties to the call are present. The storage and/or display of the text continues until the communication is complete 416.

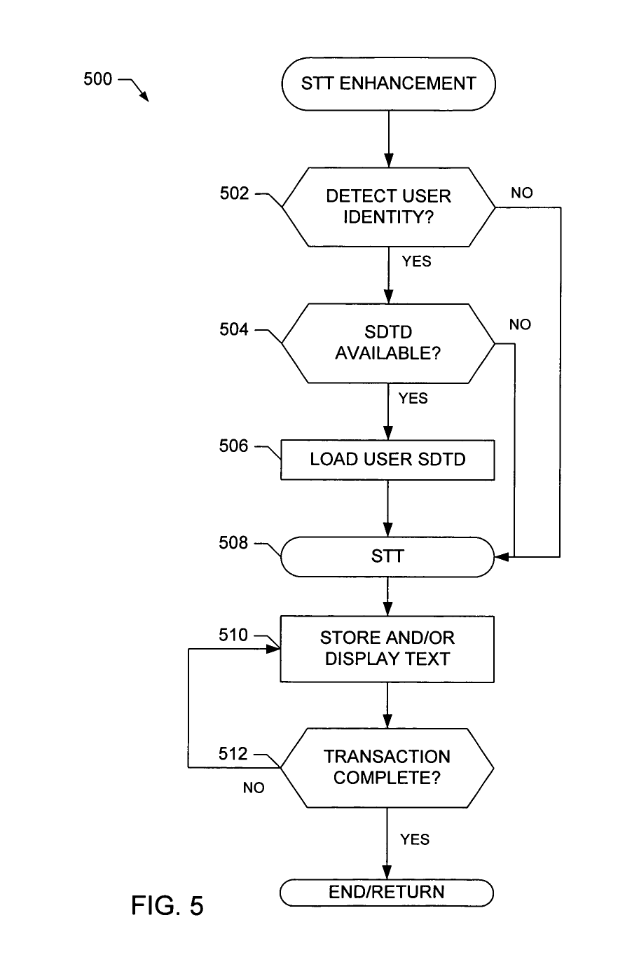

FIG. 5 shows a STT enhancement process 500 that may be carried out by, for example, a kiosk station, such as the kiosk station 108 of FIG. 1. The process 500 determines the identity. The user identity may be determined using a number of different techniques such as fingerprints, retinal scans, or other biometric information. Alternatively or additionally, user identity may be determined based on user input at a keypad or other input device. As a further alternative, the user may have an associated device (e.g., a card or an RFID device) that may be read to determine the identity.

Subsequently, it is determined if SDTD is available for the user (block 504). As noted previously with regard to FIG. 1, SDTD may be available from a number of different sources that are both local and separate from the equipment on which the process 500 is being carried out. If SDTD is available (block 504), the SDTD is loaded (block 506) and STT conversion is commenced (block 508). As STT processing proceeds, the text resulting from the processing is displayed and/or stored (block 510). According to one particularly advantageous arrangement, the text may be displayed to a ensure fidelity of instructions issued by the user. For example, in the situation of a drive through window, the staff working the window may see what the user has said rather than just hearing what was said. Such an arrangement should enhance the quality of service and customer satisfaction. Accordingly, the use of the SDTD provides enhanced STT functionality that is not possible without SDTD. Alternatively, if SDTD is not available (block 504), STT conversion may be started without SDTD (block 508).

While the transaction is in process, the display and/or storage of text may be continued (block 510). After the transaction is complete (block 512), the process 500 ends and may be restarted when a new user identity is detected.

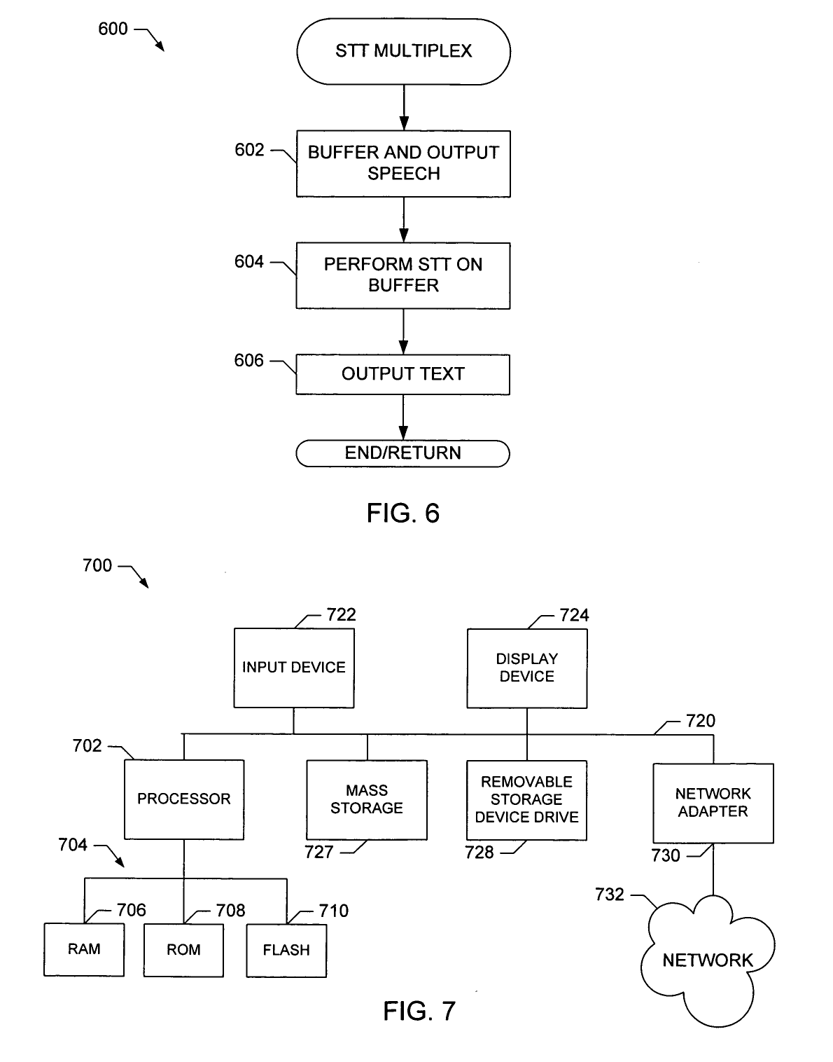

While the foregoing has focused on the transfer and usage of SDTD at a location other than the user's location, as shown in FIG. 6, each user's station may buffer and perform STT processing such that the speech and the text are transmitted, and thereby received, at approximately the same time. Such an arrangement prevents the need to exchange SDTD, but still provides high fidelity STT processing.

Referring to FIG. 6, an example STT multiplex process 600 buffers and outputs speech (block 602). For example, in one implementation the process 600 buffers instants or segments of speech. Subsequently, the process 600 performs STT processing on the buffer (block 604). After the STT conversion is complete, the text is output (block 606). The concept of the multiplexing enables the conversion of the STT on each speaker's platform (versus most of the other scenarios in which the SDTD is transferred to the receiving platform for use in STT conversion). The text resulting from the STT conversion is sent in parallel to the pulse coded modulation/digital signal processor (PCM/DSP) audio stream with the result being that the recipient has accurate STT because the conversion happened on the originating machine at which the SDTD exists. This paradigm may be useful in scenarios where the clients don't share a common SDTD format, or where privacy concerns would make it undesirable to transfer a user's SDTD information to another user.

Although the following discloses example systems including, among other components, software executed on hardware, it should be noted that such systems are merely illustrative and should not be considered as limiting. For example, it is contemplated that any or all of these hardware and software components could be embodied exclusively in dedicated hardware, exclusively in software, exclusively in firmware or in some combination of hardware, firmware and/or software. Accordingly, while the following describes example systems, persons of ordinary skill in the art will readily appreciate that the examples are not the only way to implement such systems.

As shown in FIG. 7, an example processor system 700, includes a processor 702 having associated memories 704, such as a random access memory (RAM) 706, a read only memory (ROM) 708, and a flash memory 710. The processor 702 is coupled to an interface, such as a bus 720 to which other components may be interfaced. In the illustrated example, the components interfaced to the bus 720 include an input device 722, a display device 724, a mass storage device 726, and a removable storage device drive 728. The removable storage device drive 728 may include associated removable storage media (not shown), such as magnetic or optical media. The processor system 700 may also include a network adapter 730.

The example processor system 700 may be, for example, a server, a remote device, a conventional desktop personal computer, a notebook computer, a workstation or any other computing device. The processor 702 may be any type of processing unit, such as a microprocessor from the Intel® Pentium® family of microprocessors, the Intel® Itanium® family of microprocessors, and/or the Intel XScale® family of processors. The processor 702 may include on-board analog-to-digital (A/D) and digital-to-analog (D/A) converters.

The memories 704 that are coupled to the processor 702 may be any suitable memory devices and may be sized to fit the storage and operational demands of the system 700. In particular, the flash memory 710 may be a non-volatile memory that is accessed and erased on a block-by-block basis.

The input device 722 may be implemented using a keyboard, a mouse, a touch screen, a track pad or any other device that enables a user to provide information to the processor 702. Additionally, the input device may be implemented as a sound card that is capable of processing audio (e.g., voice) into data, as well as processing data into audio. As such, the input device 722 may include on-board digital-to-analog and analog-to-digital converters (not shown).

The display device 724 may be, for example, a liquid crystal display (LCD) monitor, a cathode ray tube (CRT) monitor or any other suitable device that acts as an interface between the processor 702 and a user. The display device 724 includes any additional hardware required to interface a display screen to the processor 702.

The mass storage device 726 may be, for example, a conventional hard drive or any other magnetic or optical media that is readable by the processor 702.

The removable storage device drive 728 may be, for example, an optical drive, such as a compact disk-recordable (CD-R) drive, a compact disk-rewritable (CD-RW) drive, a digital versatile disk (DVD) drive, or any other optical drive. The removable storage device drive 728 may alternatively be, for example, a magnetic media drive. If the removable storage device drive 728 is an optical drive, the removable storage media used by the drive 728 may be a CD-R disk, a CD-RW disk, a DVD disk or any other suitable optical disk. On the other hand, if the removable storage device drive 728 is a magnetic media device, the removable storage media used by the drive 728 may be, for example, a diskette or any other suitable magnetic storage media.

The network adapter 730 may be any suitable network interface such as, for example, an Ethernet card, a wireless network card, a modem, or any other network interface suitable to connect the processor system 700 to a network 732. The network 732 to which the processor system 700 is connected may be, for example, a local area network (LAN), a wide area network (WAN), the Internet, or any other network. For example, the network could be a home network, an intranet located in a place of business, a closed network linking various locations of a business, or the Internet.

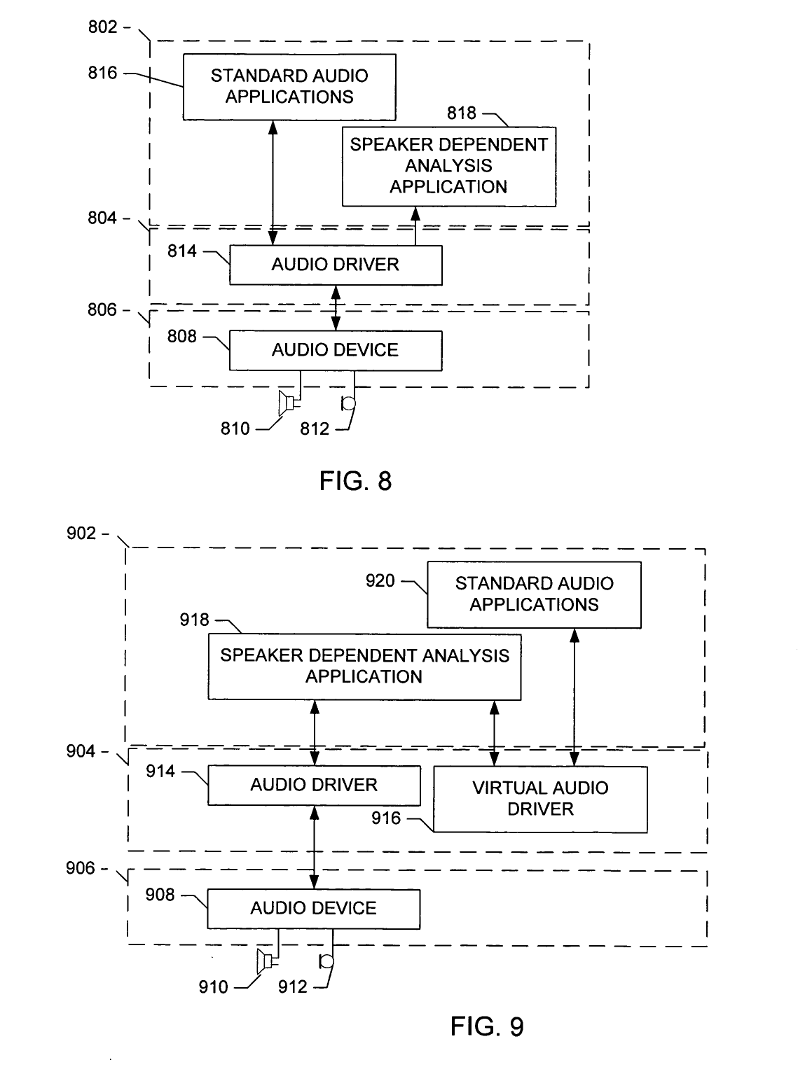

While the foregoing has described in detail various processes for utilizing and exchanging SDTD to enhance STT processing, the SDTD capability may be implemented at a low level within a computing system, such as, for example, at the driver/library/codec level. In such an arrangement, applications that use STT processing need not even be aware that SDTD is available. Two example implementations of such arrangements are described below in conjunction with FIGS. 8 and 9.

As shown in FIG. 8, the computing platform may be conceptualized at three different levels: the user level 802, the kernel level 804, and the hardware platform level 806. The hardware platform level 806 includes an audio device 808, such as an audio card or the like, to which speakers 810 and a microphone 812 may be connected. For example, in one implementation, the audio device 808 may be implemented using an integrated audio controller in a chipset, an add-in audio card, or an external DSP such as an external USB audio device.

The audio device 808 interfaces to an audio driver 814 operating at the kernel level 804. The audio driver 814 interfaces to both standard audio applications 816 and a speaker dependent analysis application 818. In such an arrangement, standard audio applications may include voice over Internet protocol (VOIP) applications and the like. The audio driver 814 interfaces to the standard audio applications 816 in a conventional manner so that such applications are unaware of the STT processing that is carried using SDTD. However, the audio driver 814 also makes the audio data, such as pulse code modulated (PCM) audio data, available to the speaker dependent analysis application 818, thereby enabling the speaker dependent analysis application 818 to perform STT conversion using any SDTD that may be available.

As with the example of FIG. 8, the example of FIG. 9 shows a computing platform including user 902, kernel 904, and hardware platform 906 levels. An audio device 908, which may be similar or identical to the audio device 808, forms part of the hardware platform level 906.

The kernel level implementation of FIG. 9, however, differs from the kernel level implementation of FIG. 8 because the kernel level 904 includes a standard audio driver 914 and a virtual audio driver 916. As shown in FIG. 9, a speaker dependent analysis application 918 is coupled to both the standard audio drive 914 and the virtual audio driver 916. Further, the virtual audio driver 916 is also coupled to standard audio applications 920.

In such an arrangement, the speaker dependent analysis application 918 proxies audio information from the standard audio driver 914 to the virtual audio driver 916, which, in turn, passes such information to the standard audio applications 920. In this manner, the standard audio applications 920 are unaware that STT using SDTD is even occurring and, therefore, the interfacing of the standard audio applications 920 need not change.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of performing speech to text conversion at a first location, the method comprising:
determining an identity of a speaker;
accessing a directory to determine a location at which speaker dependent training data associated with the speaker is stored;
loading speaker dependent training data associated with the speaker; and
performing speech to text conversion using the speaker dependent training data associated with the speaker.

2. A method as defined by claim 1, wherein determining the identity of the speaker comprises determining a unique identifier associated with the speaker.

3. A method as defined by claim 2, wherein the unique identifier is stored in a radio frequency device proximate the speaker.

4. A method as defined by claim 1, wherein determining the identity of the speaker comprises receiving a user indication of the speaker identity.

5. A method as defined by claim 1, wherein determining the identity of the speaker comprises attempting to perform speech to text conversion and assessing the results thereof.

6. A method as defined by claim 1, wherein loading speaker dependent training data associated with the speaker comprises accessing a repository of speaker dependent training data that is remote from the speaker.

7. A method as defined by claim 1, wherein performing speech to text comprises multiplexing text and speech.

8. A method of performing speech to text conversion comprising:
receiving a communication to provide speaker dependent training data associated with speaker from a first location to a second location;
providing the speaker dependent training data associated with the speaker from the first location to the second location; and
performing speech to text conversion using the speaker dependent training data associated with the speaker.

9. A method as defined by claim 8, further comprising:
storing second speaker dependent training data at the second location;
receiving a communication to provide the second speaker dependent training data from the second location to the first location; and
providing the second speaker dependent training data from the second location to the first location.

10. A method as defined by claim 9, wherein the first location and the second location comprise a peer to peer relationship.

11. A method as defined by claim 8, wherein second speaker dependent training data is stored at the second location.

12. A method as defined by claim 11, further comprising performing speech to text conversion using the second speaker dependent training data at the second location.

13. A method as defined by claim 12, wherein the speech to text conversion comprises subtitling, translation, or transcription.

14. A method as defined by claim 11, wherein the second location comprises a pointer to third speaker dependent training data stored as a third location.

15. A method as defined by claim 8, wherein performing speech to text comprises multiplexing text and speech.

16. A method as defined by claim 8, wherein performing speech to text conversion using the speaker dependent training data associated with the speaker comprises an audio driver receiving audio and passing the audio to a speaker dependent analysis application.

17. A method as defined by claim 16, wherein performing speech to text conversion using the speaker dependent training data associated with the speaker comprises virtual audio driver that passes audio information to other audio applications.

18. An article of manufacture comprising a machine-accessible medium having a plurality of machine accessible instructions that, when executed, cause a machine to:
determine an identity of a speaker;
access a directory to determine a location at which speaker dependent training data associated with the speaker is stored;
load speaker dependent training data associated with the speaker; and
perform speech to text conversion using the speaker dependent training data associated with the speaker.

19. A machine-accessible medium as defined by claim 18, wherein determining the identity of the speaker comprises determining a unique identifier associated with the speaker.

20. A machine-accessible medium as defined by claim 18, wherein determining the identity of the speaker comprises receiving a user indication of the speaker identity.

21. A machine-accessible medium as defined by claim 18, wherein determining the identity of the speaker comprises attempting to perform speech to text conversion and assessing the results thereof.

22. A machine-accessible medium as defined by claim 18, wherein loading speaker dependent training data associated with the speaker comprises accessing a repository of speaker dependent training data that is remote from the speaker.

23. A method as defined by claim 18, wherein performing speech to text comprises multiplexing text and speech.

24. An article of manufacture comprising a machine-accessible medium having a plurality of machine accessible instructions that, when executed, cause a machine to:
receive a communication to provide speaker dependent training data associated with a speaker from a first location to a second location;
provide the speaker dependent training data associated with the speaker from the first location to the second location; and
perform speech to text conversion using the speaker dependent training data associated with the speaker.

25. A method as defined by claim 24, wherein performing speech to text comprises multiplexing text and speech.
